(19) United States
(12) Patent Application Publication
(10) Pub. No.: US 2020/0245268 A1
(43) Pub. Date: Jul. 30, 2020

(54) WIRELESS COMMUNICATION METHOD AND WIRELESS COMMUNICATION SYSTEM USING STANDARD RADIO WAVES

(71) Applicant: CHIPSEN CO., LTD, Seoul (KR)

(72) Inventor: Jee Hoon LIM, Gwangmyeong-si (KR)

(73) Assignee: CHIPSEN CO., LTD, Seoul (KR)

(21) Appl. No.: 15/768,878

(22) PCT Filed: Sep. 6, 2017
(86) PCT No.: PCT/KR2017/009756

§ 371 Date: Apr. 17, 2018

(30) Foreign Application Priority Data
Sep. 12, 2016 (KR) 10-2016-0116941

(51) Int. Cl. H04W 56/00

(52) U.S. Cl. CPC H04W 56/001

(57) ABSTRACT

Disclosed are a wireless communication method and system using standard radio waves. The wireless communication method includes: setting in which a server and wireless communication apparatus individually receive standard radio waves and are set to standard time for time synchronization; acquiring for schedule information regarding operation time when the wireless communication apparatus performs a predetermined operation with the time synchronization; determining in which the wireless communication apparatus determines whether a first event occurs based on the schedule information; and first generating in which the wireless communication apparatus generates first event information corresponding to an occurrence result of the first event. Accordingly, time synchronization is performed using a standard radio wave time signal, and a wireless communication apparatus performs wireless communication at predetermined time based on standard time set by a standard radio wave time signal or performs sequential wireless communication, thereby preventing delaying in communication, and performing flexible wireless communication.

### BACKGROUND OF THE INVENTION

### Field of the Invention

The present invention relates to a wireless communication method and a wireless communication system using standard radio waves, and more particularly, to a wireless communication method and a wireless communication system using standard radio waves, which are capable of performing communication at precisely synchronized time using the standard radio waves.

### Related Art

In wireless communication in the related art, wireless communication is performed through communication between a master site and a slave site. In this case, the wireless communication is performed through time synchronization using a network time protocol (NTP).

However, in the case of the time synchronization using the NTP, it is simple to install and apply. However, since the time synchronization is performed through a network, a time delay of the network itself is consumed and the resulting error is significant. Therefore, it is difficult to perform accurate wireless communication at a predetermined time.

In order to solve such a problem, a wireless communication rule setting method is used in advance. However, there is a problem that it is difficult to perform flexible communication between communication sites as well as troublesome resetting because a communication method, and the like are fixed after once set.

In addition, there is a problem that it is difficult to confirm whether the time synchronization is performed in a place that is locally isolated such as a book area or a military area.

### SUMMARY OF THE INVENTION

The present invention is contrived to solve the problems and the present invention provides a wireless communication apparatus and a wireless communication method using standard radio waves, which perform time synchronization using a standard time signal, allow the wireless communication apparatus to perform wireless communication at a predetermined time based on a standard time set by a standard radio wave time signal, or perform sequential wireless communication to prevent a communication delay and perform flexible wireless communication.

In an aspect, provided is a wireless communication method. The wireless communication method includes: a setting step in which a server and a wireless communication apparatus individually receive standard radio waves and are set to a standard time to perform time synchronization; an acquisition step of acquiring schedule information regarding an operation time when the wireless communication apparatus performs a predetermined operation when the time synchronization is performed; a first determination step in which the wireless communication apparatus determines whether a first event occurs based on the schedule information; and a first generation step in which the wireless communication apparatus generates first event information corresponding to an occurrence result of the first event.

The first determination step may be a step in which the wireless communication apparatus determines that the first event occurs when a current time based on the set standard time coincides with the operation time, and the first generation step may include a step of generating first event information for activating the wireless communication apparatus when it is determined that the first event occurs, and an inactivation step of activating the wireless communication apparatus when it is determined that the first event does not occur.

In addition, the wireless communication method may further include: a second determination step in which the wireless communication apparatus determines whether a second event occurs while the first event information is generated; a second generation step in which the wireless communication apparatus generates second event information when it is determined that the second event occurs; a third generation step in which the wireless communication apparatus generates first status information by matching occurrence time information regarding the time when the second event occurs with the second event information; and a step in which the wireless communication apparatus transmits the first status information to the server.

Further, the second event may occur as the wireless communication apparatus is tagged with an external device.

In addition, the second determination step may be a step in which the wireless communication apparatus determines whether the second event occurs at a predetermined interval based on the schedule information, and may further include a third determination step in which the wireless communication apparatus determines whether the second event ends after performing the second generation step at least once, a third generation step in which the wireless communication apparatus generates second event end information when it is determined that the second event ends, a fourth generation step in which the wireless communication apparatus generates second status information by matching end time information regarding the time when the second event ends with the second event end information, and a step in which the wireless communication apparatus transmits the second status information to the server.

Further, the wireless communication method may further include: a calculation step in which the server calculates an elapsed time of the second event based on the first status information and the second status information; and an output step in which the server calculates and outputs a fee to be charged based on the elapsed time of the second event.

In addition, the second event may occur as the wireless communication apparatus senses an external device, the second event may end when the wireless communication apparatus resenses the same external device after initially sensing the external device, and the external device may be an object to be stored, which is enabled to be sensed through a separate sensor.

Further, the first generation step may further include an output step of outputting the current time in the form of at least one of audio, video, illumination, and vibration so that a user who uses the wireless communication apparatus remembers the current time when the wireless communication apparatus is activated.

In addition, the first determination step may be a step in which the wireless communication apparatus determines that the first event occurs when the current time based on the set standard time coincides with the operation time, and the first generation step may be a step in which the wireless communication apparatus generates information on the elapsed time from the time when the first event occurs as first event information at a predetermined interval when it is determined that the first event occurs, and may further include a step in which the wireless communication apparatus outputs the elapsed time in the form of at least one of the audio, the video, and the vibration when the first event information is generated.

Further, the wireless communication apparatus may be attached to an object to be managed, of which an identification number is managed by the server, and the operation time may be a change anticipation time when a change of a status of the object to be managed is anticipated.

In addition, the wireless communication apparatus may further include: a positional information generating step in which the wireless communication apparatus generates positional information at the time when the first event information is generated when generating the first event information at the predetermined interval; a fifth generation step in which the wireless communication apparatus generates third status information by matching the first event information and the positional information; and a step in which the wireless communication apparatus transmits the third status information to the server.

Further, the first determination step may be a step in which the wireless communication apparatus determines that the first event occurs when the current time based on the set standard time coincides with the operation time, and the first generation step may be a step in which the wireless communication apparatus generates positional information at the current time as the first event information when it is determined that the first event occurs, and may further include a fifth generation step in which the wireless communication apparatus generates third status information by matching the current time and the positional information.

In addition, the operation time may have the form of a time table having a regular time interval from a predetermined time.

Further, the first determination step may be a step in which the wireless communication apparatus determines that the first event occurs when the current time based on the set standard time coincides with the operation time, and the first generation step may include a first collection step of collecting peripheral information including at least one of temperature, humidity, air cleanliness, and the amount of sunshine of a place where the wireless communication apparatus is positioned when it is determined that the first event occurs, and a step in which the wireless communication apparatus generates fourth status information by matching occurrence time information regarding the time when the first event occurs as the first event information with the peripheral information.

In addition, the first determination step may be a step in which the wireless communication apparatus determines that the first event occurs when the current time based on the set standard time coincides with the operation time, and the first generation step may include a second collection step in which the wireless communication apparatus collects biometric information including at least one of pulse rate, body temperature, blood pressure, electrocardiogram, blood sugar, exercise amount, and blood flow amount of a user when it is determined that the first event occurs, and a step in which the wireless communication apparatus generates fifth status information by matching the occurrence time information regarding the time when the first event occurs as the first event information with the biometric information.

Further, the operation time may be a management cycle or an examination cycle of an object to be managed by the wireless communication apparatus, and the wireless communication method may further include a step in which the wireless communication apparatus acquires a manufacturing date or a production date which is manufacturing or production date information of the object to be managed, and the first determination step may be a step in which the wireless communication apparatus determines that the first event occurs when the current time based on the set standard time corresponds to the management cycle or examination cycle, and the first generation step may be a step in which the wireless communication apparatus generates a management date or a management name based on the production date or manufacturing date and the examination cycle or management cycle as the first event information, and may further include a step in which the wireless communication apparatus generates management information by matching the object to be managed and the first event information when the first event information is generated, and a step in which the wireless communication apparatus transmits the management information to the server.

In addition, the management date may include at least one of an inspection date, a validity term date, a discard date, the expiration date, and a release date of the object to be managed, which are calculated by aggregating the management cycle or examination cycle from the manufacturing or production date by the wireless communication apparatus.

Meanwhile, in another aspect, provided is a wireless communication system. The wireless communication system includes: a wireless communication apparatus set to a standard time by receiving standard radio waves, determining whether a first event occurs by acquiring schedule information regarding an operation time when a predetermined operation is performed, and generating first event information corresponding to an occurrence result of the first event; and a server set to the standard time by receiving the standard radio waves, performing time synchronization with the wireless communication apparatus, and receiving status information from the wireless communication apparatus.

Accordingly, time synchronization is performed using a standard radio wave time signal and a wireless communication apparatus performs wireless communication at a predetermined time based on a standard time set by a standard radio wave time signal or performs sequential wireless communication, thereby preventing a communication delay and performing flexible wireless communication.

### BRIEF DESCRIPTION OF THE DRAWINGS

FIG. 1 is a diagram provided to describe a wireless communication system according to an embodiment of the present invention.

FIG. 2 is a flowchart provided to describe a wireless communication method system according to an embodiment of the present invention.

FIG. 3 is a flowchart provided to describe a wireless communication method system according to an embodiment of the present invention.

FIG. 4 is a flowchart provided to describe a wireless communication method system according to another embodiment of the present invention.

FIG. 5 is a flowchart provided to describe a wireless communication method system according to yet another embodiment of the present invention.

FIG. 6 is a flowchart provided to describe a wireless communication method system according to still yet another embodiment of the present invention.

FIGS. 7A and 7B are diagrams provided to describe a wireless communication method system according to an embodiment of the present invention.

FIGS. 8A and 8B are diagrams provided to describe a wireless communication method system according to another embodiment of the present invention.

FIGS. 9A and 9B are diagrams provided to describe a wireless communication method system according to yet another embodiment of the present invention.

### DESCRIPTION OF EXEMPLARY EMBODIMENTS

Hereinafter, embodiments of the present invention will be described in more detail with reference to the drawings.

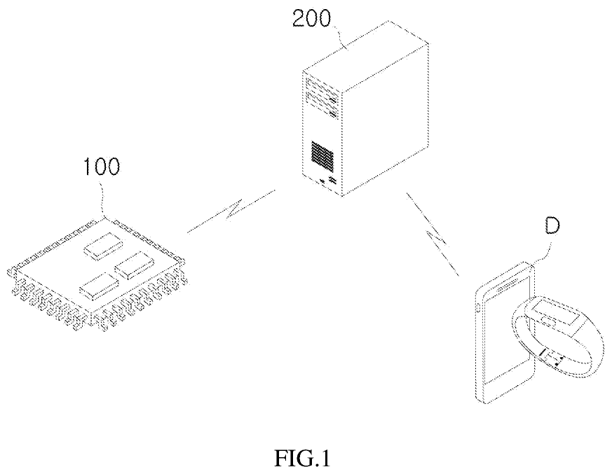

FIG. 1 is a diagram provided to describe a wireless communication system according to an embodiment of the present invention.

The wireless communication system is provided to prevent a communication delay or communication error between a wireless communication apparatus performing wireless communication and a server and transmit/receive predetermined information at the same time when the wireless communication apparatus and the server synchronize with each other or perform a predetermined operation by the wireless communication apparatus.

In addition, the wireless communication system according to the embodiment sets a standard time using a standard time signal rather than time synchronization using a network time protocol (NTP), thereby preventing an error which occurs in the time synchronization of the wireless communication apparatus 100 and the server 200 itself and performing a predetermined operation based on an accurate time.

To this end, the wireless communication system is constituted by the wireless communication apparatus 100 and the server 200 as illustrated in FIG. 1 and as necessary, the wireless communication apparatus 100 or the server 200 interlocks with an external device D to perform communication.

First, the wireless communication apparatus 100 is provided to include a standard radio wave reception module for receiving standard radio waves for time setting.

In addition, the wireless communication apparatus 100 receives the standard radio wave time signal and sets a standard time.

Further, the wireless communication apparatus 100 acquires schedule information including an operation time for allowing a predetermined operation to be performed.

In a process of acquiring the schedule information by the wireless communication apparatus 100, the schedule information may be stored and provided in advance in the course of driving the wireless communication apparatus or may be received and stored from the server 200 in real time.

In addition, the wireless communication apparatus 100 interlocks with the external device D and collects predetermined information through the external device D or allows the external device D to perform the predetermined operation.

Specifically, when the wireless communication apparatus is used in a medical institution, the external device D is a device attached to a body of a medical examination subject. The wireless communication apparatus allows biometric information including at least one of a body temperature, heart rate, blood pressure, blood glucose, blood flow, exercise amount, and oxygen saturation of the medical examination subject to be collected.

Alternatively, the wireless communication apparatus 100 itself may be attached to the body of the medical examination subject to measure at least one of the biometric information.

To this end, the wireless communication apparatus 100 may include a sensor capable of sensing at least one of the biometric information other than a module for receiving the standard radio waves.

In the case where the wireless communication apparatus 100 according to another embodiment is used in a storage in which dangerous goods such as explosives, preservation articles in which preservation is important such as foods, and the like, the external device D is directly attached to the storage or article and the wireless communication apparatus allows peripheral information including at least one of a temperature, humidity, an amount of sunshine, and a wind in the storage or of a place where the article is stored to be collected through the external device D.

Of course, as described above, the wireless communication apparatus 100 itself may be installed in the storage or attached to the article so as to directly measure at least one of the peripheral information.

In addition, when the wireless communication apparatus 100 collects the peripheral information or the biometric information, the wireless communication apparatus 100 collects or measures the corresponding information or allows a predetermined operation to be performed based on the schedule information including an operation time.

Specifically, hereinafter, a case where the wireless communication apparatus 100 collects the biometric information according to an embodiment will be described as an example.

When the wireless communication apparatus 100 receives the standard radio wave set the standard time, the wireless communication apparatus 100 performs time synchronization with the server 200 and then, acquires the schedule information.

In addition, the schedule information includes information on a time when the biometric information needs to be collected.

Specifically, when the biometric information needs to be collected at 9:00 am, 11:00 am, 1:00 pm, and 3:00 pm, the schedule information includes information on all the times when the biometric information needs to be collected in the form of a time table.

Then, the wireless communication apparatus 100 determines whether a first event occurs based on the standard time and determines whether a current time based on the standard time coincides with the time information included in the schedule information.

Accordingly, when the current time is 9:00, the current time is compared with the time information included in the schedule information and it is determined that the current time coincides with the time information included in the schedule information and the predetermined operation for allowing the wireless communication apparatus 100 to collect the biometric information is performed at the above time.

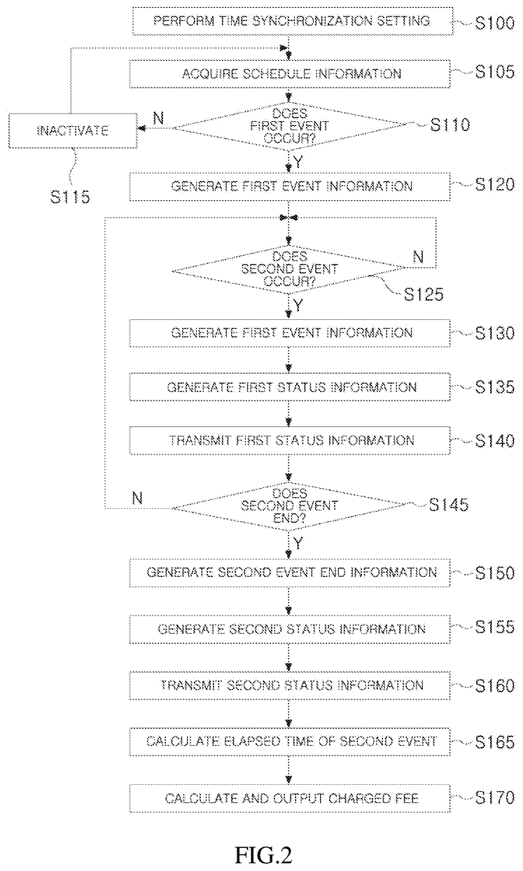

A more specific embodiment will be described in FIGS. 2 to 6.

Meanwhile, the server 200 is provided to transmit/receive information by interlocking with the wireless communication apparatus 100.

In particular, the server 200 is provided to include a module capable of receiving the standard radio waves like the wireless communication apparatus 100, and the time is set to the standard time using the standard radio wave time signal and the time synchronization may be thus performed without transmitting/receiving communication for the time synchronization.

In addition, the server 200 may receive the schedule information including the operation time which is a time at which the wireless communication apparatus 100 performs the predetermined operation in advance or receive the schedule information from the outside and transmit the schedule information to the wireless communication apparatus 100.

Further, the server 200 communicates with the external device D such as a mobile terminal or a management terminal owned by a user so that the user may check status information generated by the wireless communication apparatus 100 through the external device D.

Specifically, when a case where the wireless communication apparatus 100 according to the embodiment interlocks with a separate device for calculating a parking fee is taken as an example, in a case where the wireless communication apparatus 100 senses that a vehicle for parking enters through the separate device, the wireless communication apparatus 100 calculates a start time when the parking starts.

In addition, the wireless communication apparatus 100 calculates an elapsed time from the start time at predetermined time interval until the vehicle is advanced, calculates the parking fee to be charged based on the current time at predetermined time interval, and transmits information on the calculated parking fee to the server 200.

Then, the user accesses the server 200 using the external device D owned thereby to confirm the information on the parking fee or receives the information on the parking fee from the server 200 to confirm the amount in real time.

In addition, the server 200 recalculates the schedule information including the operation time when the wireless communication apparatus 100 needs to operate based on the status information collected from the wireless communication apparatus 100 and transmit the recalculated schedule information to the wireless communication apparatus 100.

To this end, the server 200 may include a separate algorithm for recalculating the scheduling information.

FIG. 2 is a flowchart provided to describe a wireless communication method system according to an embodiment of the present invention.

The wireless communication method according to the embodiment is a method for the wireless communication apparatus 100 to perform wireless communication for commuting to and departing from an employee, inventory management of managed articles, parking fee calculation, and the like.

First, the server 200 and the wireless communication apparatus 100 individually receive the standard radio waves and are set to the standard time, thereby setting the time synchronization (S100).

The server 200 and the wireless communication apparatus 100 share time information with each other in real time through the time synchronization setting step S100 so that the time synchronization need not be performed and receive the standard radio waves from a standard radio transmission station, and as a result, the time synchronization having high reliability may be performed between the server 200 and the wireless communication apparatus 100 at the standard time.

When the time synchronization setting step S100 is completed, the wireless communication apparatus 100 acquires the schedule information regarding the operation time for performing a predetermined operation (S105).

Herein, the predetermined operation performed by the wireless communication apparatus 100 may be differently set according to a type of a place where the wireless communication apparatus 100 is used or an object to which the wireless communication apparatus 100 is attached.

Specifically, when the wireless communication apparatus 100 is attached to an employee ID card for a commuting history of an employee or is attached to an article to be subject to inventory management, the predetermined operation may be an operation in which the wireless communication apparatus 100 is tagged to the external device D for the commuting history or an operation in which the wireless communication apparatus 100 is tagged to the external device D for inventory management.

Further, when the wireless communication apparatus 100 is used for the parking fee calculation, the predetermined operation may be an operation of receiving information related to departure or entry from the external device D capable of sensing the entry/exit of the vehicle and the operation time means a time when the above operation needs to be performed or a period when the above operation is performed.

Thereafter, the wireless communication apparatus 100 determines whether a first event occurs based on the schedule information (S110).

In determining whether the first event occurs, when the current time based on the set standard time coincides with the operation time included in the schedule information or the current time is within the operation time included in the schedule information, the wireless communication apparatus 100 determines that the first event occurs.

When it is determined that the first event does not occur (S110-N), the wireless communication apparatus 100 is inactivated (S115).

On the contrary, when it is determined that the first event occurs (S110-Y), first event information is generated so as to activate the wireless communication apparatus 100 (S120).

In addition, the wireless communication apparatus 100 which is activated by the generation of the first event information determines whether a second event occurs (S125). Herein, when it is determined that the second event does not occur (S125-N), the wireless communication apparatus 100 returns to the step (S120) of generating the first event information or the step (S220) of determining whether the first event occurs.

Further, the step (S125) of determining whether the second event occurs according to the embodiment is periodically performed at a predetermined interval based on the schedule information.

On the contrary, when it is determined that the second event occurs (S125-Y), the wireless communication apparatus 100 generates second event information (S130).

Herein, with respect to whether the second event occurs, if the wireless communication apparatus 100 is attached to the employee ID card or the object to be managed, when the wireless communication apparatus 100 and the external device D are tagged with each other, it is determined that the second event occurs and when the wireless communication apparatus 100 is used for calculating the parking fee, in the case where the entry of the vehicle is sensed through the external device D, it is determined that the second event occurs.

In addition, the second event information is generated so that the wireless communication apparatus 100 corresponds to a set-up or type of the tagged external device D when the wireless communication apparatus 100 is attached to the employee ID card or the object to be managed and generated to correspond to the exit or entry of the vehicle when the parking fee is calculated.

Specifically, in the case of the parking fee calculation as an example, when the current time of the wireless communication apparatus 100 is within a time range in which the exist or entry of the vehicle needs to be managed and the wireless communication apparatus 100 senses the entry of the vehicle, the second event information is information including identification number and entry information of the corresponding vehicle.

Thereafter, the wireless communication apparatus 100 generates the first status information by matching occurrence time information which is the time when the second event occurs with the second event information (S135).

In addition, the wireless communication apparatus 100 transmits the first status information to the server 200 (S140).

Thereafter, the wireless communication apparatus 100 determines whether the second event ends (S145).

When it is determined that the second event does not end (S145-N), the wireless communication apparatus 100 returns to the second determination step (S125) for determining whether the second event occurs and the second determination step (S125) may be performed at a predetermined interval.

Herein, the third determination step (S145) in which the wireless communication apparatus 100 determines whether the second event ends is performed only when the second generation step (S130) in which the wireless communication apparatus generates the second event information is performed at least once.

Meanwhile, when it is determined that the second event ends (S145-Y), the wireless communication apparatus 100 generates second event end information (S150).

Specifically, when a case where the wireless communication apparatus 100 is used in a parking fee payment system is taken as an example, in the case where the vehicle having the identification number included in the first status information exits to be resensed from the external device D, the wireless communication apparatus 100 determines that the second event ends and generates the identification number of the vehicle which exits as the second event end information.

Then, the wireless communication apparatus 100 generates the second status information by matching the end time information on the time when the occurrence of the second event ends as the second event end information (S155).

In the case of parking settlement, the second status information is information obtained by matching the identification number of the vehicle which exits as the second event end information with the time information on the time when the external device D resenses the vehicle as the end time information.

In addition, the wireless communication apparatus 100 transmits the second status information to the server 200 (S160).

Thereafter, the server 200 calculates the elapsed time of the second event (S165).

Herein, the elapsed time of the second event is generated based on the generated first and second status information. Specifically, a difference between the occurrence time and the end time of the second event is calculated through the first status information including the information on the time when the second event occurs and the second status information including the information on the time when the second event ends to calculate the elapsed time.

Therefore, in the case of the parking fee payment system, the elapsed time is calculated by calculating the difference between an entry time of the vehicle and an exit time of the vehicle.

In the embodiment, it is described that the elapsed time of the second event is calculated by the server 200, but this is merely an example for easy description and the wireless communication apparatus 100 may calculate the elapsed time and transmit the calculated elapsed time to the server 200, of course.

When the step (S165) of calculating the elapsed time of the second event is completed, the server 200 calculates and outputs a fee to be charged based on the elapsed time (S170).

To this end, an algorithm or basic information for calculating a fee, such as a parking fee per hour may be registered in the server 200 in advance.

Hereinabove, in the case where the wireless communication apparatus 100 is used in the parking fee payment system in the process of determining whether the second event information is generated, when exit or entry information is received from the external device D, it is assumed that the second event information is generated, but this is merely an example and the second event may be provided to be generated when the wireless communication apparatus 100 senses the external device D, of course.

That is, an object to be parked or to be stored itself becomes the external device D, and as a result, the wireless communication apparatus 100 may be provided to sense the object that is the external device D. To this end, the wireless communication apparatus 100 may include a sensor for sensing the object.

In addition, In FIG. 1, a process from the step (S100) in which the time synchronization is performed up to the step (S170) in which the fee is calculate and output is described through one flowchart, but this is merely an example.

Among the specific examples, when it is not necessary to separately determine whether the second event ends like the case where the wireless communication apparatus 100 is attached to the employee ID card or the object to be managed, steps after the step (S145) of determining whether the second event ends may not be performed.

Although not illustrated in FIG. 1, the step (S120) in which the first event information is generated may include a step in which the wireless communication apparatus 100 outputs the current time in the form of at least one of audio, video, illumination, and vibration when the current time based on the standard time coincides with the operation time.

Specifically, when a case where the user needs to take a medication at a predetermined time is taken as an example, the wireless communication apparatus 100 may be attached to a case where the medication is stored or provided in the case itself.

In this case, when the time when the user needs to take the medication is included in the schedule information as the operation time and the current time coincides with the time included in the schedule information, it is determined that the first event occurs (S110) and the first event information which activates the wireless communication apparatus 100 is generated (S120) and thereafter, the current time in the form of at least one of the audio, the video, the illumination, and the vibration. Therefore, the user may take the medication at a predetermined time interval.

In addition, in the wireless communication method according to the embodiment, the wireless communication apparatus 100 is activated only for a predetermined time, thereby preventing waste of electric power.

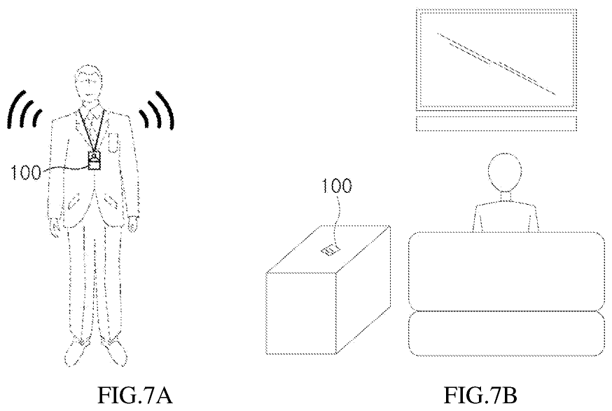

Specifically, when the case where the wireless communication apparatus 100 is provided in the employee ID card or attached to the employee ID card is taken as an example as illustrated in FIG. 7, if the schedule information on the operation time of the wireless communication apparatus 100 is from 8:00 am to 7:00 pm and the current time set by receiving the standard radio waves is 8:30 am, the current time coincides with the operation time, and as a result, the wireless communication apparatus 100 determines that the first event occurs (S110-Y).

Then, the wireless communication apparatus 100 generates the first event information for activation as illustrated in FIG. 7A (S120) and then, performs the step (S125) of determining whether the second event occurs through tagging with a device which is capable of tagging with the employee ID card.

When the current time of the wireless communication apparatus 100 is 9:00 PM, the current time does not coincide with the schedule information, so that the wireless communication apparatus 100 is inactivated as illustrated in FIG. 7B to save the electric power of the wireless communication apparatus 100.

As described in the specific example, the wireless communication apparatus 100 according to the embodiment may selectively perform activation and deactivation based on the obtained schedule information, thereby preventing power wastage and saving energy.

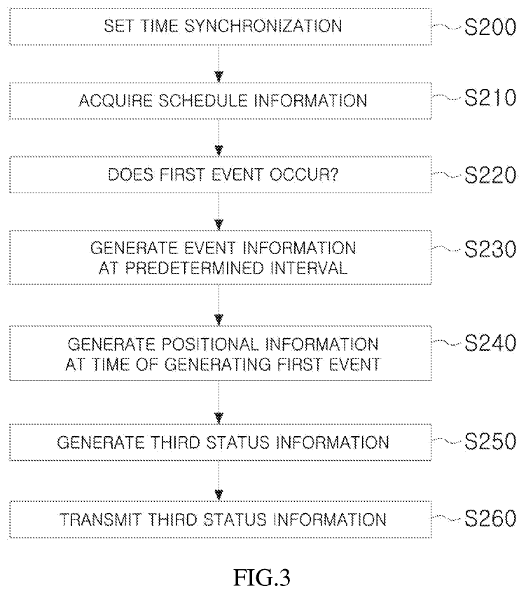

Meanwhile, FIG. 3 is a flowchart provided to describe a wireless communication method according to an embodiment of the present invention.

In the wireless communication method, the wireless communication apparatus 100 is provided for a case where the object to be managed including dangerous materials and dangerous equipment moves.

First, the wireless communication apparatus 100 and the server 200 receive the standard radio waves and are set to the standard time, thereby performing the time synchronization (S200).

Thereafter, the wireless communication apparatus 100 acquires schedule information on the operation time which is the time at which a location of the object to be managed is changed, and as a result, a status of the object to be managed is changed or the time when the status needs to be changed (S210). Herein, the schedule information may be received through the server 200 or may be directly input through a separate input device.

Then, the wireless communication apparatus 100 determines whether the first event occurs (S220).

Herein, whether the first event occurs is determined based on whether the operation time set in the wireless communication apparatus 100 coincides with the operation time based on the standard radio waves.

When the current time does not coincide with the operation time (S220-N), the process returns to the step (S220) of determining whether the first event occurs.

On the contrary, when it is determined that the first event occurs as the current time and the operation time coincide with each other (S220-Y), the wireless communication apparatus 100 generates the elapsed time from the occurrence time of the first event at a predetermined time interval as the first event information (S230).

Specifically, when one hour is set as the predetermined time interval, the wireless communication apparatus 100 causes the first event information to be generated every hour interval and the first event information is continuously generated until a separate end signal is received or input like a case where when the first event occurs at 8:00 am, 9:00 am which is one hour after 8:00 am is primarily generated as the first event information and 10:00 am is secondarily generated as the first event information.

When the first event information is generated, the wireless communication apparatus 100 generates positional information at the time when the first event information is generated (S240).

In addition, the wireless communication apparatus 100 matches the first event information and the positional information when the first event information is generated with each other to generate third status information (S250).

Then, the wireless communication apparatus 100 transmits the third status information to the server 200 (S260).

Through the above process, the server 200 may receive the positional information of the wireless communication apparatus 100 for each time at a predetermined time interval, so that the server 200 may grasp a movement route and a current location of the object to be managed, to which the wireless communication apparatus 100 is attached.

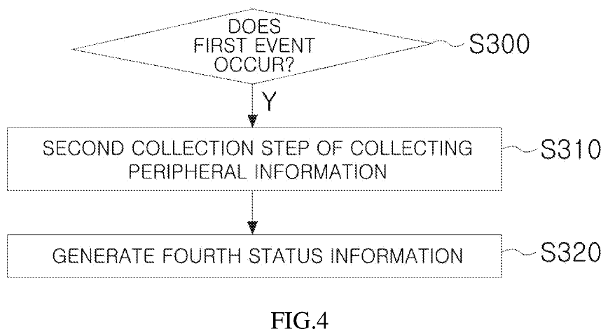

Meanwhile, FIG. 4 is a flowchart provided to describe a wireless communication method according to another embodiment of the present invention. The embodiment is a wireless communication method when the wireless communication apparatus 100 is installed at a location to be managed such as a warehouse or attached to an article to be managed, which requires for maintaining freshness.

In the wireless communication method according to another embodiment of the present invention, the step of setting the time synchronization and the step of acquiring the schedule information are omitted for easy description.

The schedule information according to the embodiment is a time table for the operation time when the wireless communication apparatus 100 needs to collect information.

First, the wireless communication apparatus 100 determines whether the first event occurs (S300). Herein, the wireless communication apparatus 100 determines that the first event occurs when the current time based on the set standard time coincides with the operation time.

When the wireless communication apparatus 100 determines that the current time and the operation time do not coincide with each other (S310-N), the wireless communication apparatus 100 is inactivated as illustrated in FIG. 2 (S115).

On the contrary, when the wireless communication apparatus 100 determines that the first event occurs due to the coincidence of the current time and the operation time (S310-Y), the wireless communication apparatus 100 collects the peripheral information of a place where the object to be managed is positioned (S310).

Herein, the peripheral information is information including at least one of the temperature, the humidity, air cleanliness, and the amount of sunshine of the place where the wireless communication apparatus 100 is attached or installed. The information may be collected through the external device D or directly measured and collected through a sensor included in the wireless communication apparatus 100.

Then, the wireless communication apparatus 100 generates fourth status information by matching occurrence time information for the time when the first event occurs with the collected peripheral information (S320).

Thereafter, the wireless communication apparatus 100 may transmit the fourth status information to the server 200.

The peripheral information collected according to the wireless communication method including the above steps may be analyzed by the server 200 and the server 200 may control an air conditioning system, and the like through the wireless communication apparatus 100 according to the analysis result.

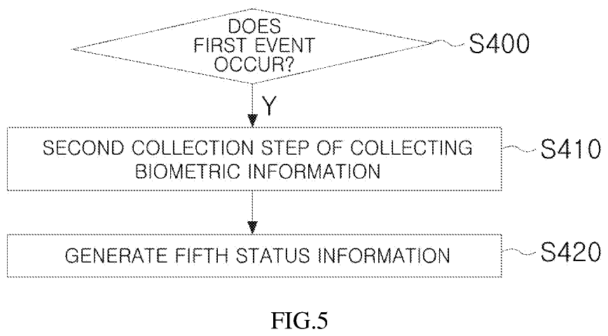

Meanwhile, FIG. 5 is a flowchart provided to describe a wireless communication method according to yet another embodiment of the present invention and corresponds to a case where the wireless communication method is performed in a place where a medical device is used and in this case, the wireless communication apparatus 100 is an apparatus attached to an apparatus for measuring the biometric information or an apparatus for measuring the biometric information.

In FIG. 5, similarly in FIG. 4, the step of setting the time synchronization and the step of acquiring the schedule information are omitted for easy description.

The schedule information according to the embodiment is a time table for the operation time when the wireless communication apparatus 100 needs to collect information.

First, the wireless communication apparatus 100 determines whether the first event occurs (S400). Herein, the wireless communication apparatus 100 determines that the first event occurs when the current time based on the set standard time coincides with the operation time.

When the wireless communication apparatus 100 determines that the current time and the operation time do not coincide with each other (S400-N), the wireless communication apparatus 100 is inactivated as illustrated in FIG. 2 (S115).

On the contrary, when the wireless communication apparatus 100 determines that the first event occurs due to the coincidence of the current time and the operation time (S400-Y), the wireless communication apparatus 100 collects the biometric information of a person to be examined (S410).

Herein, the biometric information is information including at least one of pulse rate, body temperature, blood pressure, electrocardiogram, blood sugar, exercise amount, and blood flow amount of a person to be examined, who wears the wireless communication apparatus 100. The information may be collected through the external device D or directly measured and collected through the sensor included in the wireless communication apparatus 100.

Then, the wireless communication apparatus 100 generates fifth status information by matching the occurrence time information for the time when the first event occurs with the collected peripheral information (S420).

Thereafter, the wireless communication apparatus 100 may transmit the fifth status information to the server 200.

In this case, a plurality of wireless communication apparatuses 100 is provided and attached to different subjects to be examined to collect the biometric information. In this case, the fifth status information includes identification information for identifying the person to be examined.

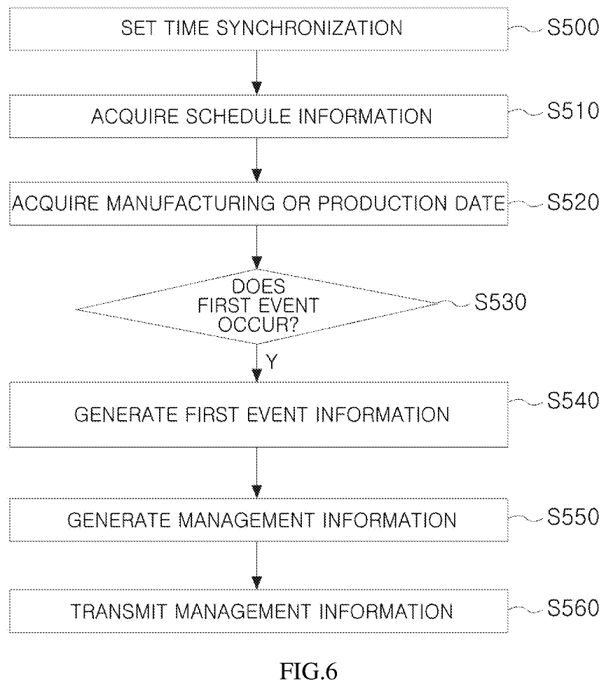

Meanwhile, FIG. 6 is a flowchart provided to describe a wireless communication method according to still yet another embodiment of the present invention. The wireless communication method according to the embodiment corresponds to a case where an object to be managed over a long period of time, such as a building or a stock item needs to be managed.

First, as described above, the wireless communication apparatus 100 and the server 200 individually receive the standard radio waves and are set to the standard time, thereby performing the time synchronization (S500).

Thereafter, the wireless communication apparatus 100 acquires schedule information on the operation time, which is a cycle during which the status of the object to be managed needs to be checked (S510).

Here, the cycle during which the status is to be checked may be a cycle during which a safety check of the building is to be carried out, a cycle during which a building material is to be replaced, etc. in the case of a building and may mean a cycle during which the stock item is to be taken out, a cycle during which the stock item is to be inspected, a cycle during which the stock item is to be discarded, etc. in the case of the stock item.

In addition, the wireless communication apparatus 100 acquires a manufacturing date or a production date, which is information on a manufacturing or production date of the object to be managed (S520).

Thereafter, the wireless communication apparatus 100 determines whether the first event occurs (S530).

Herein, according to a criterion for determining whether the first event occurs, it is determined that the first event occurs when the current time of the wireless communication apparatus 100 coincides with the cycle included in the schedule information from the manufacturing date or production date is aggregated.

In addition, when it is determined that the first event has occurred (S530-Y), the wireless communication apparatus 100 generates a management name and a management date of the object to be managed as the first event information based on the production date or the manufacturing date and the cycle included in the schedule information (S540).

In the above description, the management date means a date including at least one of an inspection date, a validity term date, a discard date, the expiration date, and a release date of the object to be managed.

Then, the wireless communication apparatus 100 generates management information by matching the identification number of the object to be managed with the management date which is the first event information (S550).

Thereafter, the wireless communication apparatus 100 transmits the management information to the server 200 (S560).

Through the above process, the buildings or objects to be preserved or to be stored over a long period of time may be periodically managed and a time when the wireless communication needs to be performed is set based on the standard time according to the standard radio waves, and as a result, the wireless communication apparatus 100 may perform the operation according to predetermined schedule information even though a delay of communication or a network error occurs.

FIG. 7 is a diagram provided to describe a wireless communication method according to an embodiment of the present invention.

In the wireless communication method, the wireless communication apparatus 100 is used as the employee ID card and FIG. 7A is a diagram for describing a status where the current time of the wireless communication apparatus 100 in which the standard time is set through the standard radio waves is included in the schedule information and it is determined that the first event occurs, and as a result, the wireless communication apparatus 100 is activated and FIG. 7B is a diagram for describing a status where the current time of the wireless communication apparatus 100 is not included in the schedule information and it is determined that the first event does not occur, and as a result, the wireless communication apparatus 100 is inactivated.

As illustrated in FIG. 7A, when the wireless communication apparatus 100 is tagged with an external device for absenteeism and tardiness records while the first event information activated when the first event occurs is generated, the wireless communication apparatus 100 determines that the second event occurs and generates tagging information regarding a tagging fact as the second event information.

The tagging information is information including the identification number of the tagged external device D in addition to the identification number of the wireless communication apparatus 100.

In addition, the wireless communication apparatus 100 generates the first status information as the time information on the time when the second event occurs, that is, the time when the wireless communication apparatus 100 and the external device D are tagged with each other matches the second event information and transmits the generated first status information to the server 200.

Through the above process, absenteeism and tardiness management including commuting is easily performed and managed through the wireless communication apparatus 100.

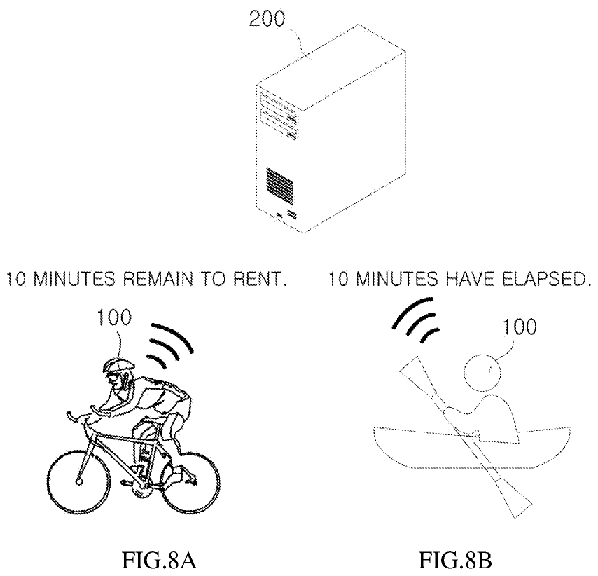

FIG. 8 is a diagram provided to describe a wireless communication method system according to another embodiment of the present invention.

The wireless communication method according to another embodiment of the present invention may be a case where the wireless communication apparatus 100 is attached to a rental article so that the rental article is managed. A case where the wireless communication apparatus 100 is attached to the rental article such as a bicycle or a boat will be specifically described below as an example in FIG. 8.

In the case where the wireless communication apparatus 100 is attached to the rental article, the operation time included in the schedule information is an anticipated time or a take-out time when the rental article is taken out from the server 200 in the step in which the wireless communication apparatus acquires the schedule information in FIG. 1.

In addition, In the first generation step S120 in which the first event information is generated, the wireless communication apparatus 100 generates information on the elapsed time from the occurrence time of the first event as the first event information at a predetermined time interval.

Specifically, when a signal for generating the first event information is received from the server 200 every 10 minutes or the predetermined time interval is input through a separate input device, the wireless communication apparatus 100 generates information on an elapsed time which is a difference between the time when the first event information is generated and the current time as the first event information every 10 minutes.

In addition, when the first event information is generated, the wireless communication apparatus 100 may include the step of outputting the elapsed time in the form of at least one of the audio, the video, and the vibration.

Thus, it is possible to provide information on a rental time to the user who rents the rental article.

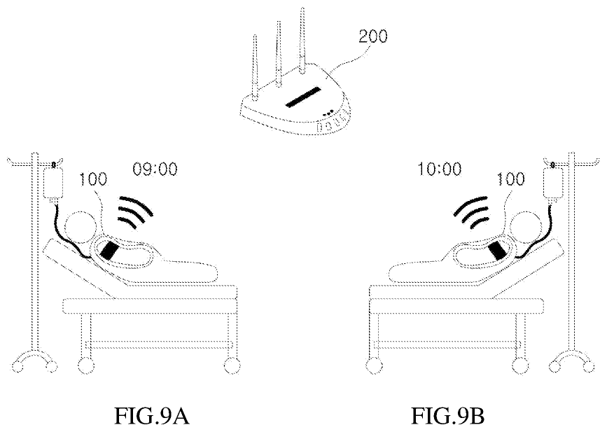

FIG. 9 is a diagram provided to describe a wireless communication method according to still yet another embodiment of the present invention and illustrates an example of a case where the wireless communication method is performed by a medical institution such as a hospital.

After the time synchronization is performed through receiving the standard radio waves with the server 200 while the wireless communication apparatus 100 is worn in a part of the body of the person to be examined, each of the wireless communication apparatuses 100 acquires the schedule information.

Herein, the schedule information includes the time when the biometric information of the person to be examined needs to be collected as the operation time.

More specifically, a case where the operation time included in the schedule information acquired by the wireless communication apparatus 100 of FIG. 9A is 9:00 and the operation time included in the schedule information acquired by the wireless communication apparatus 100 of FIG. 9B is 9:30 will be described.

When the current time is 9:00 based on the acquired schedule information, the wireless communication apparatus 100 of FIG. 9A determines that the first event occurs and collects the biometric information of the person to be examined at the corresponding time. In this case, the biometric information to be collected from the person to be examined may be included in the schedule information.

Meanwhile, the wireless communication apparatus 100 of FIG. 9B determines that the first event information is not generated to maintain an inactivated state because the current time and the operation time included in the schedule information do not coincide with each other.

Through the above process, the wireless communication method may collect the same type or different types of biometric information from different persons to be examined at the same time.

While the embodiments of the present invention have been illustrated and described above, the present invention is not limited to the aforementioned specific embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

What is claimed is:

1. A wireless communication method comprising;
a setting step in which a server and a wireless communication apparatus individually receive standard radio waves and are set to a standard time to perform time synchronization;
an acquisition step of acquiring schedule information regarding an operation time when the wireless communication apparatus performs a predetermined operation when the time synchronization is performed;
a first determination step in which the wireless communication apparatus determines whether a first event occurs based on the schedule information; and
a first generation step in which the wireless communication apparatus generates first event information corresponding to an occurrence result of the first event.

2. The wireless communication method of claim 1, wherein the first determination step is a step in which the wireless communication apparatus determines that the first event occurs when a current time based on the set standard time coincides with the operation time, and
the first generation step includes,
a step of generating first event information for activating the wireless communication apparatus when it is determined that the first event occurs, and
an inactivation step of activating the wireless communication apparatus when it is determined that the first event does not occur.

3. The wireless communication method of claim 2, further comprising:
a second determination step in which the wireless communication apparatus determines whether a second event occurs while the first event information is generated;
a second generation step in which the wireless communication apparatus generates second event information when it is determined that the second event occurs;
a third generation step in which the wireless communication apparatus generates first status information by matching occurrence time information regarding the time when the second event occurs with the second event information; and
a step in which the wireless communication apparatus transmits the first status information to the server.

4. The wireless communication method of claim 3, wherein the second event occurs as the wireless communication apparatus is tagged with an external device.

5. The wireless communication method of claim 3, wherein the second determination step is a step in which the wireless communication apparatus determines whether the second event occurs at a predetermined interval based on the schedule information, and
further includes a third determination step in which the wireless communication apparatus determines whether the second event ends after performing the second generation step at least once,
a third generation step in which the wireless communication apparatus generates second event end information when it is determined that the second event ends,
a fourth generation step in which the wireless communication apparatus generates second status information by matching end time information regarding the time when the second event ends with the second event end information, and
a step in which the wireless communication apparatus transmits the second status information to the server.

6. The wireless communication method of claim 5, further comprising:
a calculation step in which the server calculates an elapsed time of the second event based on the first status information and the second status information; and
an output step in which the server calculates and outputs a fee to be charged based on the elapsed time of the second event.

7. The wireless communication method of claim 6, wherein the second event occurs as the wireless communication apparatus senses an external device,
the second event ends when the wireless communication apparatus resenses the same external device after initially sensing the external device, and
the external device is an object to be stored, which is enabled to be sensed through a separate sensor.

8. The wireless communication method of claim 2, wherein the first generation step further includes,
an output step of outputting the current time in the form of at least one of audio, video, illumination, and vibration so that a user who uses the wireless communication apparatus remembers the current time when the wireless communication apparatus is activated.

9. The wireless communication method of claim 1, wherein the first determination step is a step in which the wireless communication apparatus determines that the first event occurs when the current time based on the set standard time coincides with the operation time, and
the first generation step
is a step in which the wireless communication apparatus generates information on the elapsed time from the time when the first event occurs as first event information at a predetermined interval when it is determined that the first event occurs, and
further includes a step in which the wireless communication apparatus outputs the elapsed time in the form of at least one of the audio, the video, and the vibration when the first event information is generated.

10. The wireless communication method of claim 9, wherein the wireless communication apparatus is attached to an object to be managed, of which an identification number is managed by the server, and
the operation time is a change anticipation time when a change of a status of the object to be managed is anticipated.

11. The wireless communication method of claim 9, further comprising:
a positional information generating step in which the wireless communication apparatus generates positional information at the time when the first event information is generated when generating the first event information at the predetermined interval;
a fifth generation step in which the wireless communication apparatus generates third status information by matching the first event information and the positional information; and
a step in which the wireless communication apparatus transmits the third status information to the server.

12. The wireless communication method of claim 1, wherein the first determination step is a step in which the wireless communication apparatus determines that the first event occurs when the current time based on the set standard time coincides with the operation time, and
the first generation step
is a step in which the wireless communication apparatus generates positional information at the current time as the first event information when it is determined that the first event occurs, and
further includes a fifth generation step in which the wireless communication apparatus generates third status information by matching the current time and the positional information.

13. The wireless communication method of claim 12, wherein the operation time has the form of a time table having a regular time interval from a predetermined time.

14. The wireless communication method of claim 1, wherein the first determination step is a step in which the wireless communication apparatus determines that the first event occurs when the current time based on the set standard time coincides with the operation time, and
the first generation step includes
a first collection step of collecting peripheral information including at least one of temperature, humidity, air cleanliness, and the amount of sunshine of a place where the wireless communication apparatus is positioned when it is determined that the first event occurs, and
a step in which the wireless communication apparatus generates fourth status information by matching occurrence time information regarding the time when the first event occurs as the first event information with the peripheral information.

15. The wireless communication method of claim 1, wherein the first determination step is a step in which the wireless communication apparatus determines that the first event occurs when the current time based on the set standard time coincides with the operation time, and
the first generation step includes
a second collection step in which the wireless communication apparatus collects biometric information including at least one of pulse rate, body temperature, blood pressure, electrocardiogram, blood sugar, exercise amount, and blood flow amount of a user when it is determined that the first event occurs, and
a step in which the wireless communication apparatus generates fifth status information by matching the occurrence time information regarding the time when the first event occurs as the first event information with the biometric information.

16. The wireless communication method of claim 1, wherein the operation time is a management cycle or an examination cycle of an object to be managed by the wireless communication apparatus, and
the wireless communication method further includes a step in which the wireless communication apparatus acquires a manufacturing date or a production date which is manufacturing or production date information of the object to be managed, and
the first determination step is a step in which the wireless communication apparatus determines that the first event occurs when the current time based on the set standard time corresponds to the management cycle or examination cycle, and
the first generation step
is a step in which the wireless communication apparatus generates a management date or a management name based on the production date or manufacturing date and the examination cycle or management cycle as the first event information, and
further includes a step in which the wireless communication apparatus generates management information by matching the object to be managed and the first event information when the first event information is generated, and a step in which the wireless communication apparatus transmits the management information to the server.

17. The wireless communication method of claim 16, wherein the management date includes at least one of an inspection date, a validity term date, a discard date, the expiration date, and a release date of the object to be managed, which are calculated by aggregating the management cycle or examination cycle from the manufacturing or production date by the wireless communication apparatus.

18. A wireless communication system comprising:
a wireless communication apparatus set to a standard time by receiving standard radio waves, determining whether a first event occurs by acquiring schedule information regarding an operation time when a predetermined operation is performed, and generating first event information corresponding to an occurrence result of the first event; and
a server set to the standard time by receiving the standard radio waves, performing time synchronization with the wireless communication apparatus, and receiving status information from the wireless communication apparatus.
